(19) United States
(12) Patent Application Publication
(10) Pub. No.: US 2006/0215780 A1
(43) Pub. Date: Sep. 28, 2006

(54) Apparatus and method for transmitting a signal in a communication system

(75) Inventors: Hae-Dong Yeon, Bucheon-si (KR); Sung-Soo Kim, Seoul (KR); Yun-Sang Park, Suwon-si (KR); Bong-Gee Song, Seongnam-si (KR); Jae-Yong Lee, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd.

(21) Appl. No.: 11/388,260

(22) Filed: Mar. 24, 2006

(30) Foreign Application Priority Data
Mar. 25, 2005 (KR) 2005-25149

(51) Int. Cl. H04K 1/10

(52) U.S. Cl. 375/260

(57) ABSTRACT

In a communication system using an Orthogonal Frequency Division Multiple Access (OFDMA) scheme, at least one value mapped to the number of threshold subchannels is compared with the number of subchannels allocated to a signal transmission apparatus in an associated Orthogonal Frequency Division Multiplexing (OFDM) symbol when transmission data including m bits is input. In response to a comparison result, (m−k) bits are generated from the transmission data using at least one of clipping and rounding. The (m−k) bits are converted to an analog signal and the analog signal is transmitted. The number of threshold subchannels is preset to determine whether to use clipping, rounding or both.

### PRIORITY

This application claims priority under 35 U.S.C. § 119 to an application filed in the Korean Intellectual Property Office on Mar. 25, 2005 and assigned Serial No. 2005-25149, the contents of which are incorporated herein by reference.

### BACKGROUND OF THE INVENTION

1. Field of the Invention

The present invention generally relates to an apparatus and method for transmitting a signal in a communication system, and more particularly to an apparatus and method for transmitting a signal by considering average power of bits to be input to a Digital-to-Analog Converter (DAC) in a communication system using an Orthogonal Frequency Division Multiple Access (OFDMA) scheme.

2. Description of the Related Art

Generally, the OFDMA scheme is a scheme for effectively dividing and allocating frequency resources for users in a multi-user environment on the basis of Orthogonal Frequency Division Multiplexing (OFDM) scheme. When the OFDMA scheme is used, the effect of parallel transmission generated due to use of a plurality of subcarriers, i.e., the effect of increasing the data rate and the spectral efficiency, is obtained as in the case where the OFDM scheme is used. When the OFDMA scheme is used, problems associated with a Carrier Frequency Offset (CFO) and a Peak-to-Average Power Ratio (PAPR) must be considered as in the case where the OFDM scheme is used.

A typical example of the OFDMA communication system is a communication system based on Institute of Electrical & Electronics Engineers (IEEE) 802.16d/e standard. The IEEE 802.16d/e communication system classifies subchannels into a band Adaptive Modulation & Coding (AMC) subchannel and a diversity subchannel according to a subchannel configuration method.

The band AMC subchannel will now be described. A total frequency band for use in the IEEE 802.16d/e communication system is divided into a plurality of subbands, i.e., a plurality of bands. One or more subcarriers belonging to the plurality of bands make up one band AMC subchannel. The one or more subcarriers that are included in the band AMC subchannel are adjacent to each other. To allocate the band AMC subchannel, a Base Station (BS) must receive a feedback of Channel Quality Information (CQI) about the plurality of bands, from Mobile Stations (MSs) within coverage thereof. The BS allocates a band AMC subchannel of a band capable of providing an optimal channel state to each MS by considering the CQI fed back from each MS. In this case, band AMC subchannels within each band have a similar channel state because they are included in subcarriers adjacent to each other. Thus, the MS can apply a band AMC scheme suitable for each band AMC subchannel, thereby maximizing transmission capacity.

The diversity subchannel is configured such that one or more of the subcarriers used in the IEEE 802.16e communication system are dispersed throughout the total frequency band of the IEEE 802.16e communication system and therefore a frequency diversity gain can be obtained. Generally, a radio channel is varied in time and frequency domains. It is preferred that a diversity subchannel is allocated and a diversity gain is obtained, if it is impossible to adaptively transmit a signal according to a channel state for a specific MS or a received channel state is good or bad according to a situation of each MS. Diversity subchannels are mapped to indices of the subcarriers used in the IEEE 802.16e communication system according to a preset frequency-hoping pattern or spreading sequence.

As described above, the BS is responsible for allocating subchannels for MSs in the OFDMA communication system. Accordingly, the BS allocates all subchannels of a downlink or uplink interval to associated MSs within one frame and performs a transmission process while constantly maintaining the average power of every OFDM symbol in the downlink or uplink interval. The average power of every OFDM symbol is almost constantly maintained in the downlink interval for the MSs, but is not constantly maintained in the uplink interval in which only a subchannel allocated to an associated MS is used. If the average power of the OFDM symbol is not constantly maintained, quantization noise increases or the burden of additional hardware increases when actual hardware is implemented.

FIG. 1 is a block diagram illustrating the structure of the signal transmission apparatus in the conventional OFDMA communication system.

Referring to FIG. 1, the signal transmission apparatus is provided with a plurality of units, i.e., an encoder 100, a modulator 102, a subchannel allocator 104, an Inverse Fast Fourier Transform (IFFT) processor 106, a windowing/PAPR reducer 108, an interpolator 110, a DAC 112, and a transmitter 114.

First, when a bit stream, corresponding to information data to be transmitted from the signal transmission apparatus, is generated, it is input to the encoder 100. The encoder 100 encodes the bit stream in a preset coding scheme and then outputs the encoded bit stream to the modulator 102. The modulator 102 receives a signal output from the encoder 100, modulates the received signal in a preset modulation scheme, and outputs the modulated signal to the subchannel allocator 104. The subchannel allocator 104 receives the signal output from the demodulator 102, maps the received signal to subchannels allocated to the signal transmission apparatus in the present OFDM symbol, and outputs the mapped signal to the IFFT processor 106.

The IFFT processor 106 receives the signal output from the subchannel allocator 104, transforms the received signal according to an IFFT process, and outputs the transformed signal to the windowing/PAPR reducer 108. The windowing/PAPR reducer 108 receives the signal output from the IFFT processor 106, performs a windowing operation and an operation for spectrum shaping and PAPR reduction on the received signal, and outputs an operation result to the interpolator 110. Herein, the windowing operation performs a spectrum shaping function for satisfying a spectrum mask and the PAPR reduction operation prevents the negative effect of increasing costs and degrading the efficiency of a High Power Amplifier (HPA) due to a high PAPR. The signal transmission apparatus including the windowing/PAPR reducer 108 in FIG. 1 has been exemplarily described. Alternatively, the signal transmission apparatus may not include the windowing/PAPR reducer 108.

The interpolator 110 receives a signal output from the windowing/PAPR reducer 108, performs a 2× or 4× interpolation operation, and outputs an operation result to the DAC 112. The DAC 112 receives a signal output from the interpolator 110, generates a baseband signal through an analog conversion operation, and outputs the baseband signal to the transmitter 114. The transmitter 114 receives the baseband signal output from the DAC 112, performs a Radio Frequency (RF) process, and transmits a process result to a signal reception apparatus through an antenna.

When the signal transmission apparatus as described with reference to FIG. 1 is implemented with actual hardware, quantization noise occurs in other units except the DAC 112, the encoder 100, and the subchannel allocator 104, such that all quantization noise components occurring in the units overlaps with the baseband signal. The quantization noise occurs in a signal transmission apparatus for transmitting an uplink signal, i.e., a signal transmission apparatus of an MS as well as a signal transmission apparatus for transmitting a downlink signal, i.e., a signal transmission apparatus of a BS. As described above, the average power of every OFDM symbol is constantly maintained in the downlink interval, but is not constantly maintained in the uplink interval. That is, the average power is not constantly maintained in every OFDM symbol and a variation width is large when any subcarrier is not allocated and all subcarriers are not allocated in the uplink interval.

FIGS. 2A to 2C illustrate the quantization noise that occurs according to variation of average power of an OFDM symbol in the conventional OFDMA communication system.

In FIGS. 2A to 2C, reference numerals 202, 206, and 212 denote data distributions with a normal distribution form, and reference numerals 200, 204, and 210 denote data bits. FIGS. 2A to 2C illustrate an example in which an effective bit range of data is 10 bits (b0˜b9). For convenience of explanation, a sign bit is omitted in the effective bit range. In the OFDMA communication system, a time domain signal includes real and imaginary data. A time domain signal has the normal distributions 202, 206, and 212 on the basis of a central limit theorem. In this case, an average value of the data distributions 202, 206, and 212 depends upon the average power of an OFDM symbol.

FIG. 2A illustrates the case where the average power of an OFDM symbol is uniform. FIGS. 2B and 2C illustrate the case where the average power of an OFDM symbol is not uniform. That is, FIG. 2A illustrates the case where quantization noise does not occur because the average power of the OFDM symbol is uniform. FIGS. 2B and 2C illustrate the case where quantization noise occurs because the average power of the OFDM symbol is not uniform. Herein, the quantization noise as illustrated in FIG. 2B occurs when its average power is more than that of the OFDM symbol as illustrated in FIG. 2A, and the quantization noise as illustrated in FIG. 2C occurs when its average power is less than that of the OFDM symbol as illustrated in FIG. 2A. Because the quantization noise occurs only in the time domain signal, it does not occur in the units before the IFFT processor 106.

When the average power of every OFDM symbol is uniform as illustrated in FIG. 2A, hardware is easily implemented such that the quantization noise is minimized within the effective bit range. However, when the average power of every OFDM symbol is not uniform as described with reference to FIGS. 2B and 2C, i.e., the average power of every OFDM symbol is varied, a data value is not within the effective bit range between the Least Significant Bit (LSB) and the Most Significant Bit (MSB) as indicated by reference numerals 208 and 214. In this case, the quantization noise significantly increases in the parts 208 and 214 exceeding the effective bit range. This serves as a factor capable of increasing Error Vector Magnitude (EVM) and significantly degrading EVM performance of the signal transmission apparatus.

The EVM is defined as shown in Equation (1), and becomes a criterion for determining modulation accuracy of the signal transmission apparatus. Moreover, the EVM is an important parameter for implementing the signal transmission apparatus along with a spectrum mask.

$$EVM = \sqrt{\frac{\frac{1}{N} {\sum }_{1}^{N} ( Δ {I}^{2} + Δ {Q}^{2} )}{{S}_{max}^{2}}} \qquad ( 1 )$$

In Equation (1), S²ₘₐₓ denotes a maximum magnitude value of an outermost point of the constellation points. ΔI² and ΔQ² denote error vectors of real and imaginary axes, i.e., in-phase and quadrature phase axes, respectively. N denotes the number of subcarriers.

A need exists for a method for addressing a problem in which quantization noise and EVM increase due to variation in average power of an OFDM symbol.

### SUMMARY OF THE INVENTION

It is, therefore, an object of the present invention to provide an apparatus and method for transmitting a signal in an Orthogonal Frequency Division Multiple Access (OFDMA) communication system.

It is another object of the present invention to provide an apparatus and method for transmitting a signal by considering average power of bits to be input to a Digital-to-Analog Converter (DAC) in an Orthogonal Frequency Division Multiple Access (OFDMA) communication system.

In accordance with an aspect of the present invention, there is provided an apparatus for transmitting a signal in a communication system using an Orthogonal Frequency Division Multiple Access (OFDMA) scheme, that includes a bit selector for comparing at least one value mapped to the number of threshold subchannels with the number of subchannels allocated to the signal transmission apparatus in an associated Orthogonal Frequency Division Multiplexing (OFDM) symbol when transmission data comprising m bits is input, and generating (m−k) bits from the transmission data using at least one of clipping and rounding in response to a comparison result; and a digital-to-analog converter for converting the (m−k) bits to an analog signal, wherein the number of threshold subchannels is preset to determine whether to use clipping, rounding or both.

In accordance with another aspect of the present invention, there is provided a method for transmitting a signal in a communication system using an Orthogonal Frequency Division Multiple Access (OFDMA) scheme, that includes comparing at least one value mapped to the number of threshold subchannels with the number of subchannels allocated to a signal transmission apparatus in an associated Orthogonal Frequency Division Multiplexing (OFDM) symbol when transmission data comprising m bits is input; generating (m−k) bits from the transmission data using at least one of clipping and rounding in response to a comparison result; and converting the (m−k) bits to an analog signal and transmitting the analog signal, wherein the number of threshold subchannels is preset to determine whether to use clipping, rounding or both.

### BRIEF DESCRIPTION OF THE DRAWINGS

The above and other objects and aspects of the present invention will be more clearly understood from the following detailed description taken in conjunction with the accompanying drawings, in which:

FIG. 1 is a block diagram illustrating a structure of a signal transmission apparatus in a conventional Orthogonal Frequency Division Multiple Access (OFDMA) communication system;

FIGS. 2A to 2C illustrate quantization noise occurred according to variation in the average power of an Orthogonal Frequency Division Multiplexing (OFDM) symbol in the conventional OFDMA communication system;

FIG. 3 is a block diagram illustrating a structure of a signal transmission apparatus in an OFDMA communication system in accordance with the present invention;

FIG. 4 is a block diagram illustrating an example of an internal structure of a bit selector of FIG. 3;

FIG. 5 is a flowchart illustrating an operation process of a controller of FIG. 4;

FIG. 6 is a block diagram illustrating another example of the internal structure of the bit selector of FIG. 3; and

FIG. 7 is a flowchart illustrating an operation process of a controller of FIG. 6.

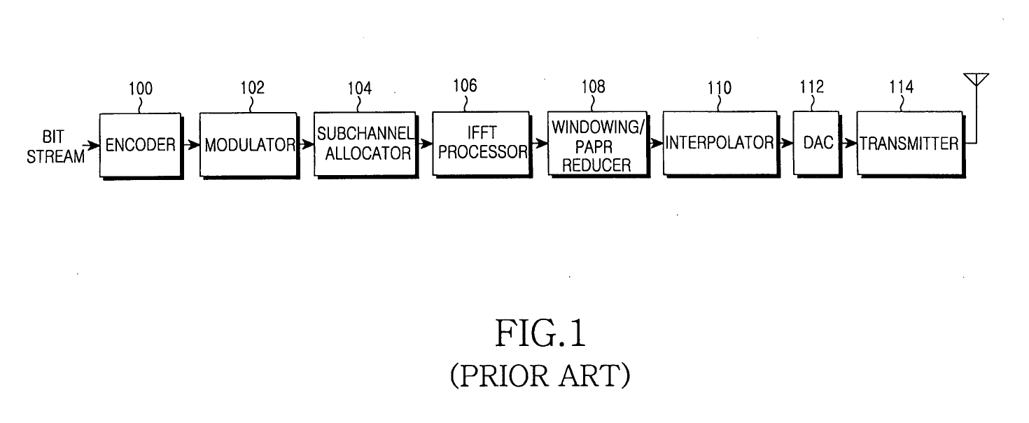

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for clarity and conciseness.

The present invention proposes an apparatus and method for transmitting a signal by considering average power of bits to be input to a Digital-to-Analog Converter (DAC) in a communication system using Orthogonal Frequency Division Multiple Access (OFDMA) scheme.

To address a problem in which quantization noise and Error Vector Magnitude (EVM) significantly increase, exceeding an effective bit range, occurring variation in the average power of an Orthogonal Frequency Division Multiplexing (OFDM) symbol as, previously described, the signal transmission apparatus of the OFDMA communication system must increase the effective bit range. The units before the DAC among the units included in the signal transmission apparatus can easily increase the effective bit range, but an increase in the effective bit range increases costs of the DAC itself. Thus, the present invention proposes a method that can reduce the quantization noise and the EVM without increasing the effective bit range in the DAC. That is, the present invention proposes the method that can reduce the quantization noise and the EVM due to a variation in the average power of the OFDM symbol by clipping or rounding bits to be input to the DAC according to the number of subchannels allocated to an interval of an OFDM symbol in which the present information data is transmitted.

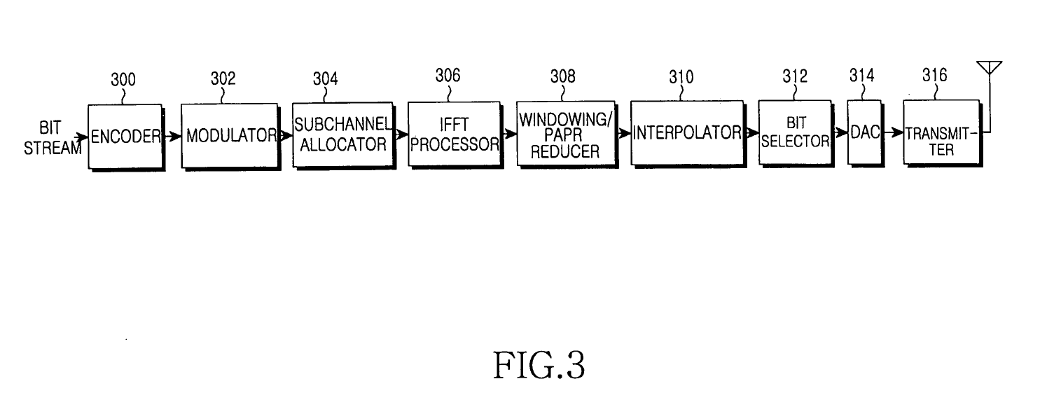

FIG. 3 is a block diagram illustrating the structure of the signal transmission apparatus in the OFDMA communication system in accordance with the present invention.

Referring to FIG. 3, the signal transmission apparatus is provided with a plurality of units, i.e., an encoder 300, a modulator 302, a subchannel allocator 304, an Inverse Fast Fourier Transform (IFFT) processor 306, a windowing/Peak-to-Average Power Ratio (PAPR) reducer 308, an interpolator 310, a bit selector 312, a DAC 314, and a transmitter 316.

First, when a bit stream corresponding to information data to be transmitted from the signal transmission apparatus is generated, the bit stream is input to the encoder 300. The encoder 300 encodes the bit stream in a preset coding scheme and then outputs the encoded bit stream to the modulator 302. The modulator 302 receives a signal output from the encoder 300, modulates the received signal in a preset modulation scheme, and outputs the modulated signal to the subchannel allocator 304. The subchannel allocator 304 receives the signal output from the demodulator 302, maps the received signal to subchannels allocated to the signal transmission apparatus in the present OFDM symbol, and outputs the mapped signal to the IFFT processor 306.

The IFFT processor 306 receives the signal output from the subchannel allocator 304, transforms the received signal according to an IFFT process, and outputs the transformed signal to the windowing/PAPR reducer 308. The windowing/PAPR reducer 308 receives the signal output from the IFFT processor 306, performs a windowing operation and an operation for spectrum shaping and PAPR reduction on the received signal, and outputs an operation result to the interpolator 310. Herein, the windowing operation performs a spectrum shaping function for satisfying a spectrum mask and the PAPR reduction operation prevents the negative effect of increasing costs and degrading the efficiency of a High Power Amplifier (HPA) due to a high PAPR. The signal transmission apparatus that includes the windowing/PAPR reducer 308 in FIG. 3 has been exemplarily described. Alternatively, the signal transmission apparatus may not include the windowing/PAPR reducer 308.

The interpolator 310 receives a signal output from the windowing/PAPR reducer 308, performs a 2× or 4× interpolation operation, and outputs an operation result to the bit selector 312. The bit selector 312 outputs a clipping or rounding result to the DAC 314 by clipping or rounding a preset number of bits from among bits included in a signal output from the interpolator 310 according to the number of allocated subcarriers. An operation of the bit selector 312 will be described below in more detail. The DAC 314 receives a signal output from the bit selector 312, generates a baseband signal through an analog conversion operation, and outputs the baseband signal to the transmitter 316. The transmitter 316 receives the baseband signal output from the DAC 314, performs a Radio Frequency (RF) process, and transmits a process result to a signal reception apparatus through an antenna.

Now, the operation of the bit selector 312 will be described in more detail.

First, a signal input to the bit selector 312 is a signal output from the interpolator 310. The signal output from the interpolator 310 is a time domain signal after the IFFT process is performed. The time domain signal includes real and imaginary data. For convenience of explanation, the time domain signal is not specially divided into the real and imaginary data. Accordingly, bits to be clipped and rounded are commonly applied to both the real data and the imaginary data. The clipping indicates that a set number of bits from among associated bits are cut from the Most Significant Bit (MSB) and the rounding indicates that a set number of bits among associated bits are cut from the Least Significant Bit (LSB).

The average power during an interval of one OFDM symbol in a time domain is the same as that during an interval of one OFDM symbol in a frequency domain. Therefore, the average power of the real and imaginary data in the units after the IFFT processor is set according to the number of subcarriers and based on the number of subchannels allocated to the present OFDM symbol in the subchannel allocator 304. The bit selector 312 selects input bits for the DAC 314 by clipping or rounding associated bits from the bits included in the signal output from the interpolator 310. For convenience of explanation, the signal output from the interpolator 310 will be referred to as the transmission data, and the bits that include the transmission data will be referred to as the transmission data bits.

Table 1 shows an example of EVM measurement results in the uplink signal transmission apparatus according to variation in the number of transmission data bits and a variation in the number of subchannels allocated by the subchannel allocator 304 during an interval of three symbols when an Institute of Electrical & Electronics Engineers (IEEE) 802.16d/e communication system corresponding to a typical OFDMA communication system uses 1,024 Fast Fourier Transform (FFT) points.

TABLE 1

| | PUSC | | | Optional PUSC | | |
|---|---|---|---|---|---|---|
| | | 10-bit | 10-bit | | 10-bit | 10-bit |
| | | output | output | | output | output |
| No. of | 11-bit | (1-bit | (1-bit | 11-bit | (1-bit | (1-bit |
| subchannels | output | clipping) | rounding) | output | clipping) | rounding) |
| 1 | 0.299062 | 0.300081 | 1.057315 | 0.354305 | 0.352409 | 1.169608 |
| 10 | 0.241243 | 0.272521 | 0.388438 | 0.181012 | 0.184768 | 0.33448 |
| 12 | 0.242628 | 0.371102 | 0.368227 | X | X | X |
| 13 | 0.181518 | 0.319207 | 0.272947 | X | X | X |
| 15 | X | X | X | 0.239256 | 0.377393 | 0.391802 |
| 16 | X | X | X | 0.239881 | 0.578292 | 0.38185 |
| 20 | X | X | X | 0.248938 | 1.011269 | 0.353523 |
| 34 | 0.19841 | 5.350411 | 0.242815 | X | X | X |
| 48 | X | X | X | 0.389504 | 9.411436 | 0.451031 |

Table 1, the EVM measurement unit is percentage (%), and X indicates that a measurement is omitted in an interval in which EVM does not vary with an increase in the number of subchannels. Table 1 shows a comparison of the case where the 11-bit input is maintained in the DAC 314, the case where only 10 bits are selected through 1-bit clipping and are input to the DAC 314, and the case where only 10 bits are selected through 1-bit rounding and are input to the DAC 314, when the units before the DAC 314 have the effective bit range of 11 bits, i.e., transmission data processed by the units before the DAC 314 is 11 bits, in the Partial Usage of Subchannel (PUSC) and Optional PUSC (OPUSC). Each of the PUSC and OPUSC schemes is one method of configuring an uplink diversity subchannel. Because the PUSC and OPUSC schemes are not directly associated with the present invention, their detailed description is omitted herein.

Among the above-described three cases, i.e., the case where the 11-bit input is maintained also in the DAC 314, the case where only 10 bits are selected through 1-bit clipping and are input to the DAC 314, and the case where only 10 bits are selected through 1-bit rounding and are input to the DAC 314 when the units before the DAC 314 have the effective bit range of 11 bits, the bit selector 312 is not used in the case where the 11-bit input is maintained in the DAC 314. However, the 1-bit clipping or rounding is performed using the bit selector 312 when only 10 bits are input to the DAC 314 through the 1-bit clipping or rounding.

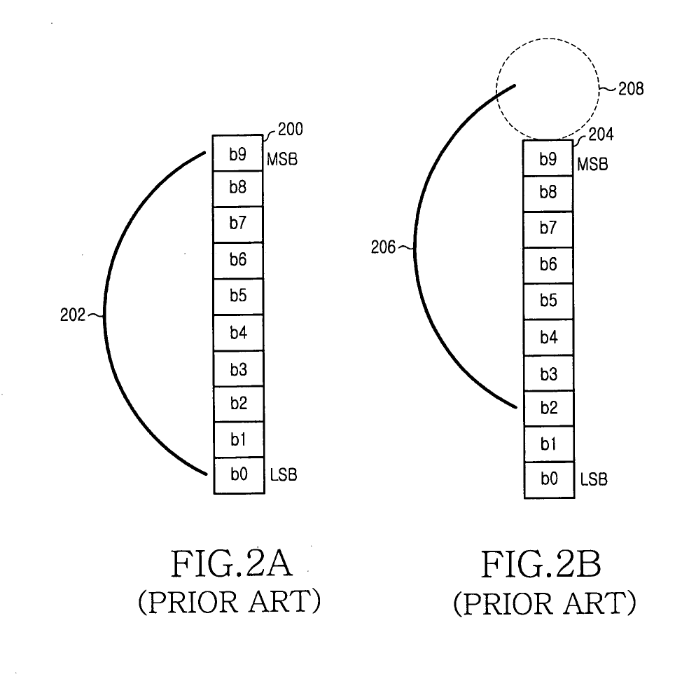

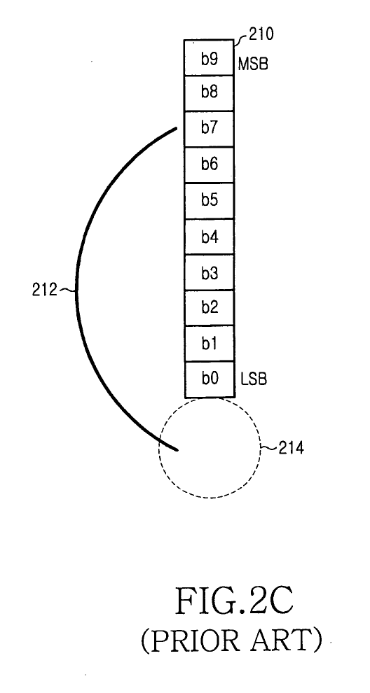

When the number of subcarriers used in an associated signal transmission apparatus is relatively small, the clipping of even just one more significant bit minimizes the degradation of EVM performance because the probability in which a data value is present in the MSB side is low as illustrated in FIG. 2C. In contrast, when the number of subcarriers used in an associated signal transmission apparatus is relatively large, data is present in the MSB side in most cases as illustrated in FIG. 2B. In this case, one MSB is the most significant bit, and quantization noise occurring due to one LSB is relatively small. Accordingly, it is efficient that one LSB is removed by rounding and 10 bits are produced.

The number of subcarriers occupying one symbol interval per subchannel is different between the PUSC and OPUSC schemes. Accordingly, a threshold value for determining one of the clipping and rounding, i.e., the number of threshold subchannels, is different between the PUSC and OPUSC schemes as shown in Table 1. When the PUSC scheme is used, it can be found that EVM is minimized in the case of clipping when the number of subchannels is 1 and 10, and EVM is minimized in the case of rounding when the number of subchannels is 12, 13, and 34 as indicated by the underlines in Table 1. On the other hand, when the OPUSC scheme is used, it can be found that EVM is minimized in the case of clipping when the number of subchannels is 1, 10, and 15, and EVM is minimized in the case of rounding when the number of subchannels is 16, 20, and 48. As a result, it can be found that the number of threshold subchannels suitable for determining whether to select the clipping or rounding is 12 in the PUSC scheme and 16 in the OPUSC scheme.

As described with reference to FIG. 3, the signal transmission apparatus can prevent an increase in the quantization noise and EVM while reducing the number of effective bits of the DAC 314 corresponding to the number of subchannels allocated to the present OFDM symbol interval. One example in which the bit selector 312 selectively performs only one of the clipping or rounding has been described with reference to FIG. 3. Of course, the bit selector 312 can perform both the clipping and the rounding.

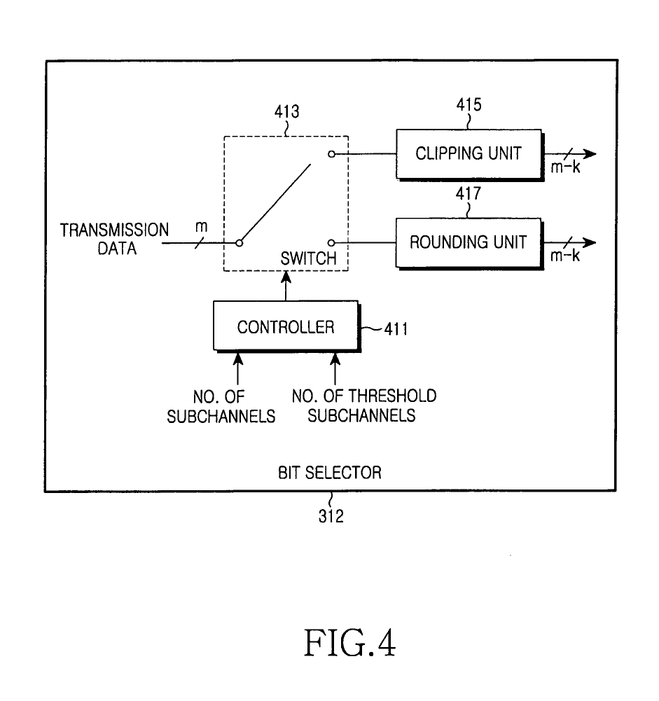

FIG. 4 is a block diagram illustrating the example of the internal structure of the bit selector 312 of FIG. 3.

Referring to FIG. 4, the bit selector 312 is provided with a controller 411, a switch 413, a clipping unit 415, and a rounding unit 417. It is assumed that the bit selector 312 as illustrated in FIG. 4 has the internal structure for clipping or rounding a preset number of k bits from m transmission data bits and providing a clipping or rounding result as an input of the DAC 314 according to the number of subchannels allocated to the present OFDM symbol as shown in Table 1. Herein, the number of k clipping or rounding bits is appropriately set by measuring the actual EVM of the signal transmission apparatus. For example, it is preferred that the number of k clipping or rounding bits is set to 1 in the conditions as shown in Table 1.

First, the m-bit transmission data is transferred to the switch 413. The switch 413 performs a switching operation such that the m-bit transmission data is transferred to the clipping unit 415 or the rounding unit 417 under control of the controller 411. Herein, the controller 411 compares the number of subchannels allocated to an associated OFDM symbol in the signal transmission apparatus with the number of threshold subchannels and controls the switching operation of the switch 413 according to a comparison result. The number of threshold subchannels is preset according to an EVM measurement result as described with reference to Table 1.

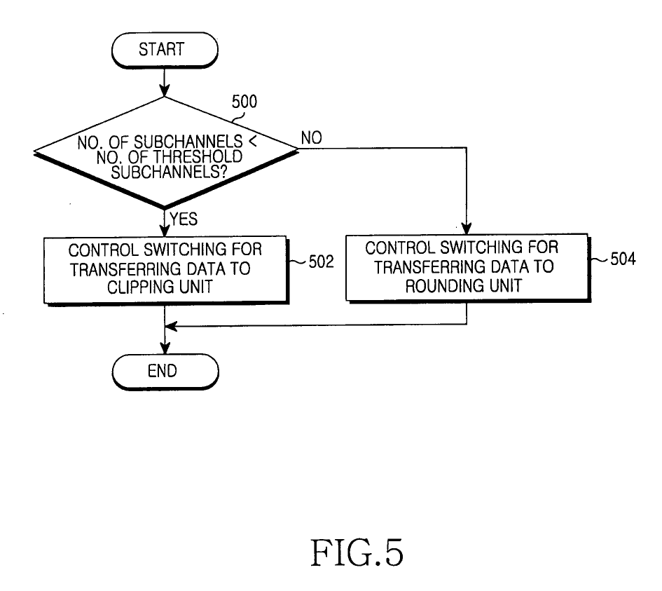

FIG. 5 is a flowchart illustrating an operation process of the controller 411 of FIG. 4.

Referring to FIG. 5, the controller 411 determines if the number of subchannels allocated to an associated OFDM symbol is less than the number of threshold subchannels in step 500. If the number of subchannels allocated to an associated OFDM symbol is less than the number of threshold subchannels, the controller 411 proceeds to step 502. In step 502, the controller 411 controls a switching operation of the switch 413 to transfer transmission data to the clipping unit 415 and then performs an end operation. However, if the number of subchannels allocated to an associated OFDM symbol is not less than the number of threshold subchannels as a determination result in step 500, the controller 411 proceeds to step 504. In step 504, the controller 411 controls the switching operation of the switch 413 to transfer transmission data to the rounding unit 417 and then performs the end operation.

The clipping unit 415 outputs a total of (m−k) bits by clipping k bits when the m-bit transmission data is transferred from the switch 413. The rounding unit 417 outputs a total of (m−k) bits by rounding k bits when the m-bit transmission data is transferred from the switch 413.

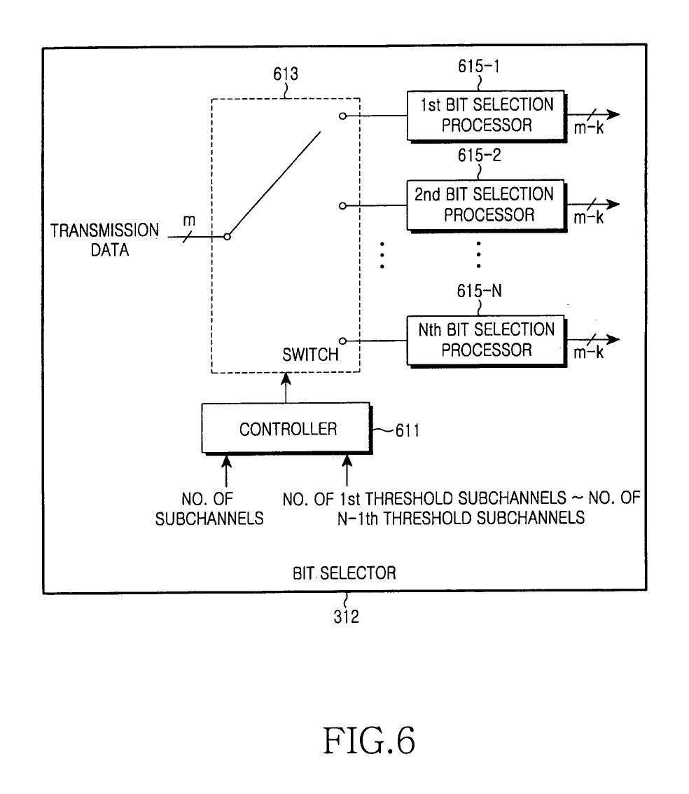

FIG. 6 is a block diagram illustrating another example of the internal structure of the bit selector 312 of FIG. 3.

Before the description of FIG. 6, it should be noted that the bit selector 312 as illustrated in FIG. 6 has the internal structure that does not only perform one of clipping and rounding but must perform both clipping and rounding.

Referring to FIG. 6, the bit selector 312 includes a controller 611, a switch 613, and N bit selection processors, i.e., 1^{st} to N^{th} bit selection processors 615-1 to 615-N. Herein, the 1^{st} bit selection processor 615-1 includes only a clipping unit for clipping k bits and the N^{th} bit selection processor 615-N includes only a rounding unit for rounding the k bits. The 2^{nd} to N−1^{th} bit selection processors 615-2 to 615-(N−1) include a clipping unit for clipping a preset number of bits and a rounding unit for rounding a preset number of bits, respectively. In the clipping and rounding units of the 2^{nd} to N−1^{th} bit selection processors 615-2 to 615-(N−1), the number of clipping bits is different from that of rounding bits.

First, m-bit transmission data is transferred to the switch 613. The switch 613 switches the m-bit transmission data to one of the 1^{st} to N^{th} bit selection processors 615-1 to 615-N under control of the controller 611. Herein, the controller 411 compares the number of subchannels allocated to an associated OFDM symbol in the signal transmission apparatus with the number of 1^{st} threshold subchannels to the number of N−1^{th} threshold subchannels, and controls the switching operation of the switch 613 in response to a comparison result. The number of 1^{st} threshold subchannels to the number of N−1^{th} threshold subchannels are preset according to the EVM measurement results as described with reference to Table 1. The number of 1^{st} threshold subchannels is smallest and the number of N−1^{th} threshold subchannels is largest according to a sequential increase. When the number of threshold subchannels to be compared with the number of subchannels allocated to an associated OFDM symbol to determine the clipping and rounding is mapped to N−1 values, the N−1 values mapped to the number of threshold subchannels to be compared are the number of 1^{st} threshold subchannels to the number of N−1^{th} threshold subchannels. The number of 1^{st} threshold subchannels to the number of N−1^{th} threshold subchannels have a value of at least 1. As described above, a value is sequentially increased from the number of 1^{st} threshold subchannels. The number of N−1^{th} threshold subchannels is the greatest.

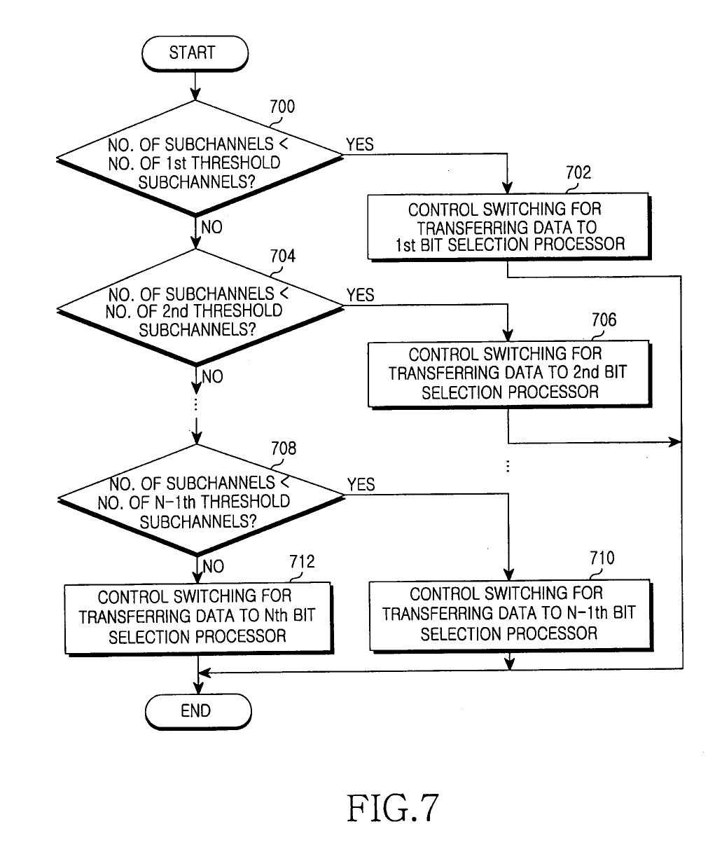

FIG. 7 is a flowchart illustrating an operation process of the controller 611 of FIG. 6.

Referring to FIG. 7, the controller 611 determines if the number of subchannels allocated to an associated OFDM symbol is less than the number of 1^{st} threshold subchannels in step 700. If the number of subchannels allocated to an associated OFDM symbol is less than the number of 1^{st} threshold subchannels, the controller 411 proceeds to step 702. In step 702, the controller 611 controls a switching operation of the switch 613 to transfer transmission data to the 1^{st} bit selection processor 615-1 and then performs an end operation.

However, if the number of subchannels allocated to an associated OFDM symbol is not less than the number of 1^{st} threshold subchannels as a determined in step 700, the controller 611 proceeds to step 704. In step 704, the controller 611 determines if the number of subchannels allocated to an associated OFDM symbol is less than the number of 2^{nd} threshold subchannels. If the number of subchannels allocated to the associated OFDM symbol is less than the number of 2^{nd} threshold subchannels, the controller 611 proceeds to step 706. In step 706, the controller 611 controls the switching operation of the switch 613 to transfer transmission data to the 2^{nd} bit selection processor 615-2 and then performs the end operation.

In this manner, the controller 611 continuously compares the number of subchannels allocated to the associated OFDM symbol with the number of associated threshold subchannels. In step 708, the controller 611 determines if the number of subchannels allocated to the associated OFDM symbol is less than the number of N−1^{th} threshold subchannels. If the number of subchannels allocated to the associated OFDM symbol is less than the number of N−1^{th} threshold subchannels, the controller 611 proceeds to step 710. In step 710, the controller 611 controls the switching operation of the switch 613 to transfer the transmission data to the N−1^{th} bit selection processor 615-(N−1) and then performs the end operation.

However, if the number of subchannels allocated to the associated OFDM symbol is not less than the number of N−1^{th} threshold subchannels as determined in step 708, the controller 611 proceeds to step 712. In step 712, the controller 611 controls a switching operation of the switch 613 to transfer the transmission data to the Nth bit selection processor 615-N and performs the end operation.

The 1^{st} bit selection processor 615-1 outputs a total of (m−k) bits by clipping k bits from the m-bit transmission data when the m-bit transmission data is transferred from the switch 613. The 2^{nd} to N−1^{th} bit selection processors 615-2 to 615-(N−1) output a total of (m−k) bits by clipping and rounding associated bits in the clipping and rounding units when the m-bit transmission data is transferred from the switch 613. The Nth bit selection processor 615-N outputs a total of (m−k) bits by rounding k bits from the m-bit transmission data when the m-bit transmission data is transferred from the switch 413.

According to the description of the present invention, the clipping and rounding operations are controlled on the basis of the number of subchannels. Of course, the clipping and rounding operations can be controlled on the basis of the number of subcarriers mapped to the number of subchannels.

As described above, the present invention can reduce quantization noise and EVM without increasing the number of effective bits to be input to the DAC when the average power of every OFDM symbol interval is not uniform and is varied. Thus, an increase in the number of input bits of the DAC can be avoided and an increase in cost of the DAC due to the increased number of input bits can be avoided.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for transmitting a signal in a communication system using an Orthogonal Frequency Division Multiple Access (OFDMA) scheme, comprising:
comparing at least one value mapped to a number of threshold subchannels with a number of subchannels allocated to a signal transmission apparatus in an associated Orthogonal Frequency Division Multiplexing (OFDM) symbol when transmission data comprising m bits is input;
generating (m−k) bits from the transmission data using at least one of clipping and rounding in response to a comparison result; and
converting the (m−k) bits to an analog signal and transmitting the analog signal,
wherein the number of threshold subchannels is preset to determine whether to use clipping, rounding or both.

2. The method of claim 1, wherein generating the (m−k) bits from the transmission data using the at least one of clipping and rounding in response to the comparison result, comprises:
when the number of threshold subchannels is mapped to one value, clipping the transmission data and generating the (m−k) bits if the number of allocated subchannels is less than the number of first threshold subchannels corresponding to the one value mapped to the number of threshold subchannels and
rounding the transmission data and generating the (m−k) bits if the number of allocated subchannels is not less than the number of first threshold subchannels.

3. The method of claim 1, wherein generating the (m−k) bits from the transmission data using the at least one of clipping and rounding in response to the comparison result, comprises:
when the number of threshold subchannels is mapped to two values corresponding to the number of first threshold subchannels and the number of second threshold subchannels, clipping the transmission data and generating the (m−k) bits if the number of allocated subchannels is less than the number of first threshold subchannels;
determining that the number of allocated subchannels is less than the number of second threshold subchannels if the number of allocated subchannels is not less than the number of first threshold subchannels;
generating the (m−k) bits from the transmission data using both the clipping and rounding if the number of allocated subchannels is less than the number of second threshold subchannels; and
rounding the transmission data and generating the (m−k) bits if the number of allocated subchannels is not less than the number of second threshold subchannels.

4. The method of claim 3, wherein generating the (m−k) bits from the transmission data using both clipping and rounding, comprises:
setting the number of bits to be clipped and the number of bits to be rounded according to the number of allocated subchannels and generating the (m−k) bits from the transmission data.

5. An apparatus for transmitting a signal in a communication system using an Orthogonal Frequency Division Multiple Access (OFDMA) scheme, comprising:
a bit selector for comparing at least one value mapped to a number of threshold subchannels with a number of subchannels allocated to the signal transmission apparatus in an associated Orthogonal Frequency Division Multiplexing (OFDM) symbol when transmission data comprising m bits is input, and generating (m−k) bits from the transmission data using at least one of clipping and rounding in response to a comparison result; and
a digital-to-analog converter for converting the (m−k) bits to an analog signal,
wherein the number of threshold subchannels is preset to determine whether to use clipping, rounding or both.

6. The apparatus of claim 5, further comprising a transmitter for transmitting the analog signal.

7. The apparatus of claim 5, wherein the bit selector comprises:
a switch for performing a switching operation such that the transmission data is input to a clipping unit or a rounding unit when the number of threshold subchannels is mapped to one value;
a controller for determining whether to use clipping or rounding in response to a comparison result, and controlling the switch to input the transmission data to the a clipping unit or the rounding unit in response to a determination result;
the clipping unit for clipping the transmission data input from the switch and generating the (m−k) bits; and
the rounding unit for rounding the transmission data input from the switch and generating the (m−k) bits.

8. The apparatus of claim 7, wherein the controller controls an operation of the switch such that the transmission data is input to the clipping unit if the number of allocated subchannels is less than the number of first threshold subchannels corresponding to the one value mapped to the number of threshold subchannels, and wherein the controller controls the operation of the switch such that the transmission data is input to the rounding unit if the number of allocated subchannels is less than the number of first threshold subchannels.

9. The apparatus of claim 5, wherein the bit selector comprises:
a switch for performing a switching operation such that the transmission data is input to one of a first bit selection processor, a second bit selection processor, and a third bit selection processor when the number of threshold subchannels is mapped to two values corresponding to the number of first threshold subchannels and the number of second threshold subchannels;
a controller for determining whether to use either clipping, rounding or both in response to a comparison result, and controlling the switch to input the transmission data to one of the first bit selection processor, the second bit selection processor, and the third bit selection processor in response to a determination result;
the first bit selection processor for clipping the transmission data input from the switch and generating the (m−k) bits;
the second bit selection processor for clipping and rounding the transmission data input from the switch and generating the (m−k) bits; and
the third bit selection processor for rounding the transmission data input from the switch and generating the (m−k) bits.

10. The apparatus of claim 9, wherein the controller controls the operation of the switch such that the transmission data is input to the first bit selection processor if the number of allocated subchannels is less than the number of first threshold subchannels,
wherein the controller determines that the number of allocated subchannels is less than the number of second threshold subchannels if the number of allocated subchannels is not less than the number of first threshold subchannels, and controls the operation of the switch such that the transmission data is input to the second bit selection processor if the number of allocated subchannels is less than the number of second threshold subchannels, and
wherein the controller controls the operation of the switch such that the transmission data is input to the third bit selection processor if the number of allocated subchannels is not less than the number of second threshold subchannels as the determination result.

11. The apparatus of claim 10, wherein the second bit selection processor sets the number of bits to be clipped and the number of bits to be rounded according to the number of allocated subchannels and generates the (m−k) bits from the transmission data.
